(19) United States
(12) Patent Application Publication
(10) Pub. No.: US 2011/0095088 A1
(43) Pub. Date: Apr. 28, 2011

(54) FLUORESCENT INFORMATION MARK AND METHODS OF ITS FABRICATION

(75) Inventors: Alexey V. LEZHNEV, Moscow (RU); Michail U. KVASHA, Moscow (RU); Galina N. DOROZHKINA, Moscow region (RU); Kirill I. DONETSKIY, Moscow (RU)

(73) Assignee: LLC FLUORESCENT INFORMATION TECHNOLOGY, Moscow (RU)

(21) Appl. No.: 12/911,021

(22) Filed: Oct. 25, 2010

(30) Foreign Application Priority Data
Oct. 23, 2009 (RU) 2009139034

(51) Int. Cl. G06K 19/06; G06K 19/02; B29C 35/08; F21V 9/04

(52) U.S. Cl. 235/491; 264/400; 252/587

(57) ABSTRACT

The invention is aimed at devising a direct application symbol mark (SMPN) which is for example two-dimensional, in which the information elements, for example depressions of the needle impact mark or regions processed by laser radiation in laser engraving using the methods described in the invention are filled with fluorescent dyes which absorb radiation at wavelengths for example either up to the short-wave transmission edge of the filter of the reader, for example in the 250-600 nm range, and which radiate in the wavelength range of the passband of the receiving channel of the reader, for example 600-700 nm, or which absorb radiation at wavelengths greater than the long wave transmission edge of the filter of the reader, for example in the 700 nm-10 micron range, and which radiate in the wavelength range of the passband of the input filter of the reader, for example 600-700 nm.

### OBJECT OF THE INVENTION

This invention relates to a field of development of optical and optoelectronic means of marking, analog-digital encoding and decoding of various objects and parts. More specifically it relates to methods and systems of application of information marks directly to the object which is being marked—direct application symbol marks SMPN (“Direct part marking”—DPM). The object of the invention is to increase the contrast of information elements of the SMPN and to reduce the effect on the reading results from the standpoint of the optical characteristics of the part surface to which the SMPN has been applied. Here the primary element which ensures high reliability of reading the marks under different conditions is the use of polymer compositions which contain fluorescent dyes.

### TECHNICAL LEVEL OF THE INVENTION

Technologies of so-called direct application symbol marks (SMPN—“Direct Part Marking”—DPM) which contain the necessary information about the item in coded form have become more and more widely used in the last several years in Europe and the US in a number of branches of industry which are characterized by increased demands for accounting, quality and reliability of parts, assemblies and articles.

In contrast to ordinary symbol marks which are printed on a paper or plastic medium and then cemented onto the object being controlled, the SMPN is applied directly to the surface of the article and can only be removed together with the material of this surface, thus its being a reliable method of monitoring the life cycle of the object up to its recycling.

The advent of the demand for SMPN has led to the development of new technologies of applying and reading these marks. Currently there are several methods of applying SMPN, the equipment for which is available on the market—needle impact application, laser (several types) application, electrochemical etching and application of paint using heat transfer and jet printing.

In the application of SMPN mainly two-dimensional coding which has a high information capacity and noise immunity is used. The main difference of the two-dimensional code consists in that to store information two orthogonal directions on the plane, vertical and horizontal, are used. As a result, in terms of the volume of information being stored the capacity of a two-dimensional code can exceed the capacity of a one-dimensional code by hundred times (for example, it can store several pages of text). If an external computer database is necessary in working with one-dimensional code, in many cases the use of a two-dimensional code makes it possible to forgo this base since the code capacity is sufficient for storage of complete information about the item. The qualitative difference of the two technologies lies in this.

For this reason two-dimensional codes are irreplaceable, for example in self-contained identification systems or if necessary to store complex characters of languages such as Japanese or Chinese. Moreover essentially all modern technologies of two-dimensional codes in contrast to one-dimensional codes contain error correction means and consequently ensure greater reliability of data protection.

2D bar codes are essentially portable information files of high density and capacity and ensure access to large volumes of information without references to the external database. That is, the technology of 2D bar coding makes it possible to store all or a large part of the necessary information in the bar code itself. 2D bar codes have predominantly a matrix form and do not use traditional bars/gaps for coding of information. Instead of a standard technology of determining the width of the bar, matrix bar codes use constructions of the “yes-no” or “one-zero” type (i.e. “on/off”-design) for encoding of information. There is a large number of varieties of 2D bar codes (for example PDF417, MaxiCode, Datamatrix).

The structure of the code supports coding of a maximum number from 1000 to 2000 symbols in one code at an information density from 100 to 340 symbols. Each code contains a start and finish group of bars which increase the height of the bar code.

2D bar code readers, in contrast to ordinary bar code scanners, first capture their picture, then analyze the image obtained, and only then extract the bar code from it and decode it. Devices which use video image analysis are necessary for effective reading of matrix codes, but can also read ordinary bar codes. The technology of video image analysis opens possibilities for reading of inscriptions, optical symbol recognition, etc.

Actually, in terms of data volumes which can be supported and functional capabilities, the technology of two-dimensional coding is intermediate between the technologies of one-dimensional bar codes and remote identification.

Initially two-dimensional codes were developed for applications which do not provide the space sufficient for accommodating an ordinary bar code identifier.

The first application for these symbols was packing of pharmaceutical preparations in health care. These packs are small in dimensions and have little room for 1D symbols. The electronics industry is also evincing interest in high density codes and two-dimensional codes in conjunction with the reduction of the dimensions of components and articles.

But reading and decoding of the SMPN are associated with major technological difficulties both in hardware and software. For a scanner which is used for reading SMPN the main problem consists in creating the illumination of the mark on a random surface necessary for obtaining an image of this quality which is necessary for reliable recognition. In the software the problem consists in increasing the decoding capacity of analysis of heterogenous “diffuse” images. Here the strong relationship between the electronic image obtained and the state of the surface and external illumination has a major effect on the decoding process.

A new, effective method is proposed for reducing this relationship by introducing into the mark a fluorescent paint with an excitation wavelength from 250 to 600 nm and by irradiation in the wavelength range of 600-700 nm. This leads to a major improvement of the image quality, in particular its contrast, and neutralizes the relationship between the picture and the nature of the surface to which the SMPN has been applied. This approach makes it possible to read marks both by an ordinary reader for reading dot peen and a special device which registers fluorescent radiation. The proposed design increases the contrast of the image, the image quality is essentially independent of the reflective and microrelief properties of the surface, greatly simplifies reading, and reduces the price of the reader. The dye protects the information elements of the mark from corrosion and consequently increases the resistance of the mark to the action of the ambient medium. High image quality makes it possible to read at a great distance and reduces the demands on quality and depth of depressions, and consequently also reduces demands on the marking device. All this in concert leads to a significant reduction of the cost of impact-point marking.

A design proposed in [U.S. Pat. No. 7,028,901] is known, where to improve reading of the mark, it is proposed that the mark be irradiated at various angles of incidence of the radiation on the surface being read. But it does not entirely solve the problem of increasing the contrast and the relationship between the image and optical properties of the surface, especially in the case of the presence of optical heterogeneities which are similar in dimensions to the information elements of the SMPN.

A similar approach is proposed in [U.S. Pat. No. 7,131,587], where to improve reading of the mark, it is proposed that the mark be irradiated at various angles of incidence of the radiation on the surface being read, but in addition the use of various wavelengths of radiation for this purpose is also proposed. But it does not entirely solve the problem of increasing the contrast and the relationship between the image and optical properties of the surface, especially in the case of the presence of optical heterogeneities which are similar in dimensions to the information elements of the SMPN.

For object identification [US2003/0106994] has proposed a protective mark which includes fluorescing and phosphorescing material with an orientation-ordered molecular structure. When the mark is irradiated with UV radiation it reradiates polarized fluorescent or phosphorescent light, whose polarization and frequency parameters are protective features for ascertaining the genuineness of the item. But this mark is not an SMPN and is easily removed from the surface of the item.

[US 2003/0006170] proposes a method and a device for multispectral representation for identification and sorting of an object. But this mark is not an SMPN and is easily removed from the surface of the item.

[US2005/230965] proposes thermal transfer printing for production of identification cards. The process includes printing of a stamp onto the paint-sensing surface of the card substrate. The stamp is printed by a combination of yellow, purple, and blue dye. The top coating have latent luminescent properties. The print stamp is visible in ordinary light and reveals bright fluorescence when illuminated by ultraviolet light. But this mark is not an SMPN and is easily removed from the surface of the item.

A description which is most similar to the proposed design is contained in the General Electric Inc. presentation [“AIM DPM Verification of Dot Peen Data Matrix Symbols on small curved surfaces” by Ron Page], where it is proposed that the dimples of the needle impact mark be filled with black or white paint to improve the image quality. But this method does not reduce the effect of external lighting and does not significantly increase contrast. Moreover methods of filling the depressions are not proposed here.

### DISCLOSURE OF THE INVENTION

The above described and other problems are solved using method and devices according to the examples described below in this invention.

The object of this invention is to devise a direct application symbol mark and methods of its production based on introducing fluorescent dyes into the information elements of the mark, such as and such that this mark continues to be read by scanners which are designed for reading ordinary marks.

The subject matter of the invention is a direct application symbol mark (SMPN) which consists of information elements formed on the surface of the part being marked in the form of conical depressions in needle impact marking or sections of the surface with microcracks and roughness which have changed its optical properties, which elements are treated with laser radiation in laser engraving, characterized in that the information elements are filled using the methods described below with fluorescent paints which absorb radiation at the wavelengths of the near UV, visible and near IR ranges. The fluorescent paints which are used and which absorb radiation at the wavelengths of the near UV, visible and near IR range are characterized in that they absorb radiation predominantly either up to the short-wave transmission edge of the filter of the reading device in the 250-600 nm range, and which radiate in the wavelength range of the passband of the receiving channel of the reading device primarily 600-700 nm, or which absorb radiation at wavelengths greater than the long-wave transmission edge of the filter of the reading device, predominantly in the 700 nm-10 micron range, and which radiate in the wavelength range of the passband of the input filter of the reading device, predominantly 600-700 nm. In needle impact or laser engraving the marks are filled using a method which is characterized in that it ensures localization of the region of filling only by the information elements. In needle-impact marking the method of filling the marks which is characterized in that fluorescent paint is applied directly to the surface of the part before impact, in the impact process some of the paint located at the contact site of the needle with the surface of the part falls into the depressions, and the paint which has remained between the depressions is then removed either by wiping or rubbing, or by cementing to a polymer film with a cementing layer which has good adhesion to the material of the fluorescent paint. In needle impact marking the method of filling the marks which is characterized in that the fluorescent paint is applied to the surface of the film which can be clamped, in the process of impact some of the paint located at the contact site of the needle with the surface of the part falls into the depressions and that remaining between the depressions is then removed along with the polymer film. In needle impact marking the method of filling the marks which is characterized in that the fluorescent paint is introduced into the cementing layer which is applied to the surface of the film which is being cemented beforehand to the part, in the process of impact some of the paint located at the contact site of the needle with the surface of the part falls into the depressions and that remaining between the depressions is then removed along with the polymer film with the cementing layer. In needle impact marking the method of filling the marks which is characterized in that the fluorescent paint is introduced into the interior of the film which contains microcapillaries or pores or microcavities, in the process of impact some of the paint located at the contact site of the needle with the surface of the part is forced out of the microcapillaries or pores or microcavities and falls into the depressions, and paint does not fall into the space between the depressions, since it remains within the film. In needle impact marking the method of filling the marks which is characterized in that to save fluorescent paint, the dye can be applied onto or into the film, not continuously, but in the form of regions which correspond to the dimensions of the mark and marking is done only in these regions. In needle impact marking the method of filling the marks which is characterized in that the fluorescent paint, using a roller, swab, brush, doctor blade or spraying, fills the depressions which have formed after impact through openings in the film which was cemented beforehand onto the part and in which in the process of needle-impact marking openings were formed.

In needle impact marking the method of filling the marks is characterized in that the fluorescent paint is applied to the surface of the needle before impact over the surface of the part by dipping the needle into a liquid composition which contains fluorescent paint. In needle impact marking the method of filling the marks which is characterized in that the fluorescent paint is applied to the surface of the needle before impact over the surface of the part through a hollow channel which is within the needle through which before or during impact the liquid composition which contains a fluorescent dye travels to the tip of the needle. In needle impact marking the method of filling the marks is characterized in that the necessary amount of the liquid composition which contains the fluorescent paint is applied to the surface of the needle before impact over the surface of the part using a nozzle or contact by a capillary with the paint. In needle impact marking the method of filling the marks which is characterized in that the fluorescent paint fills the depressions after impact in application of a liquid composition which contains fluorescent paint to the surface of the part and the dye remaining between the depressions is then removed either by wiping or rubbing or blowing off, or by cementing to a polymer film with a cementing layer which has good adhesion to the material of the fluorescent dye. In needle impact marking the method of filling the marks which is characterized in that the fluorescent paint fills the depressions after impact using a special dispenser, for example, which is used in injection printing and which applies the necessary amount of the liquid composition which contains the fluorescent paint to each depression. In laser engraving the regions which are processed using laser radiation are filled with fluorescent paint using a method which is characterized in that the fluorescent paint fills the regions processed with laser radiation in laser engraving by application of a liquid composition which contains fluorescent paint to the surface of the part and the dye remaining between the regions is then removed either by wiping or rubbing or blowing off, or by cementing to a polymer film with a cementing layer which has good adhesion to the material of the fluorescent paint. In laser engraving the regions which have been processed using laser radiation are filled with fluorescent paint using a method which is characterized in that the fluorescent paint fills the regions processed with laser radiation in laser engraving by preliminary application of a liquid composition which contains fluorescent paint to the surface of the part, with predominantly phthalocyanine or parfirin dyes which when the regions corresponding to the information elements are irradiated with the laser forms on the surface of the part a film which has good adhesion to the surface of the part, and the dye remaining between the processed regions is then removed either by wiping or rubbing or blowing off, or by cementing to a polymer film with a cementing layer which has good adhesion to the material of the fluorescent paint. In laser engraving the regions which are processed using laser radiation are filled with fluorescent paint using a method which is characterized in that the fluorescent paint fills the regions processed with laser radiation in laser engraving using a special dispenser, for example which is used in injection printing and which applies the necessary amount of the liquid composition which contains the fluorescent paint to each region of the information element. In laser engraving the regions which have been processed using laser radiation are filled with fluorescent paint using a method which is characterized in that the fluorescent paint using a roller, swab, brush, doctor blade or spraying fills the regions processed using laser radiation in laser engraving through openings in the film which was cemented beforehand onto the part and in which in the process of laser engraving openings were formed. To reduce drying time after filling the depressions or regions processed with laser radiation the fluorescent paint can be characterized in that it is produced based on photopolymer compositions and is photopolymerized using UV radiation. To reduce the drying time after filling the depressions or regions processed with laser radiation in laser engraving the method of processing the fluorescent paint can be characterized in that it is dried using IR drying. To protect from external action and UV radiation in the process of operation a protective enamel which is transparent in the visible and absorbent in the UV short wavelength ranges can be applied from overhead to the depressions or to the regions processed with laser radiation in laser engraving.

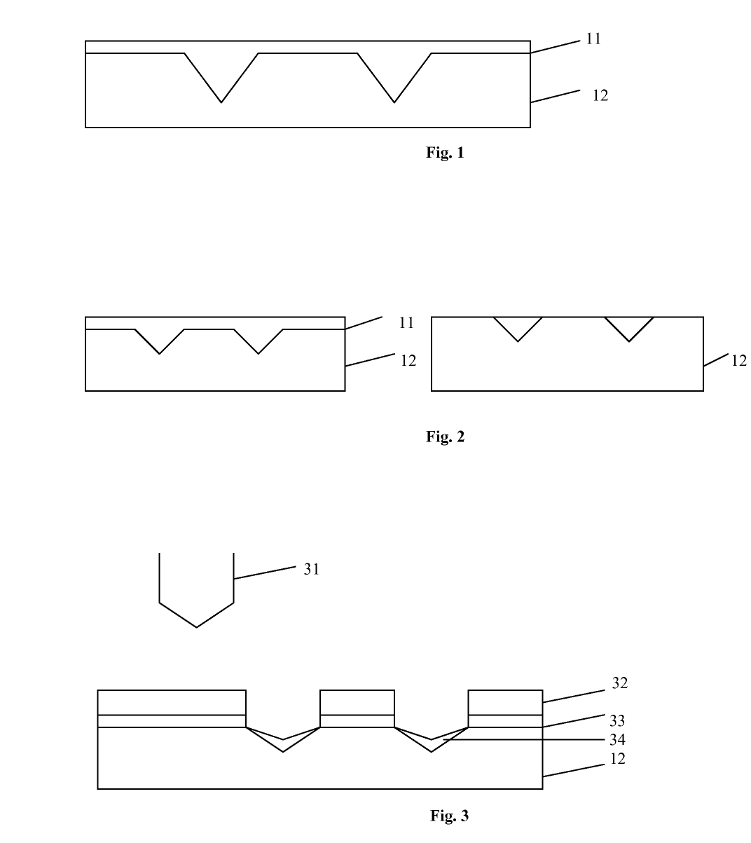

The essence of the proposed technical approach is explained using FIGS. 1-14.

FIG. 1 shows a general view of the direct application fluorescent information mark using the example of a needle impact mark.

FIG. 2 shows the direct application fluorescent information mark of the needle impact type with depressions filled using the method of pre-application of the dye to the surface of the part by dye before and after removal of the dye between the depressions.

FIG. 3 shows a direct-application fluorescent information mark of the needle impact type, filled using a film with a cementing layer which contains a fluorescent dye.

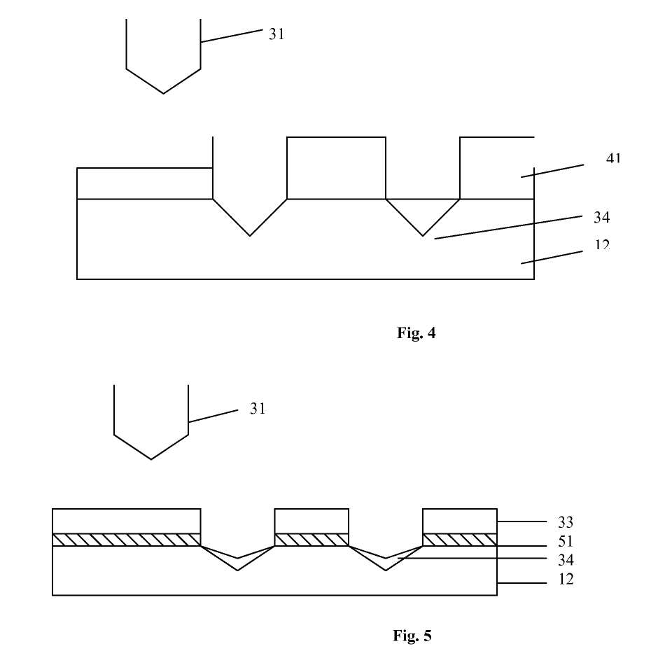

FIG. 4 shows a direct-application fluorescent information mark of the needle impact type, filled with a dye through a film cemented beforehand to the surface of the part, the openings on the film being formed in the marking process.

FIG. 5 shows a direct-application fluorescent information mark of the needle impact type, filled using a film which contains microcapillaries or pores or microcavities with a fluorescent dye.

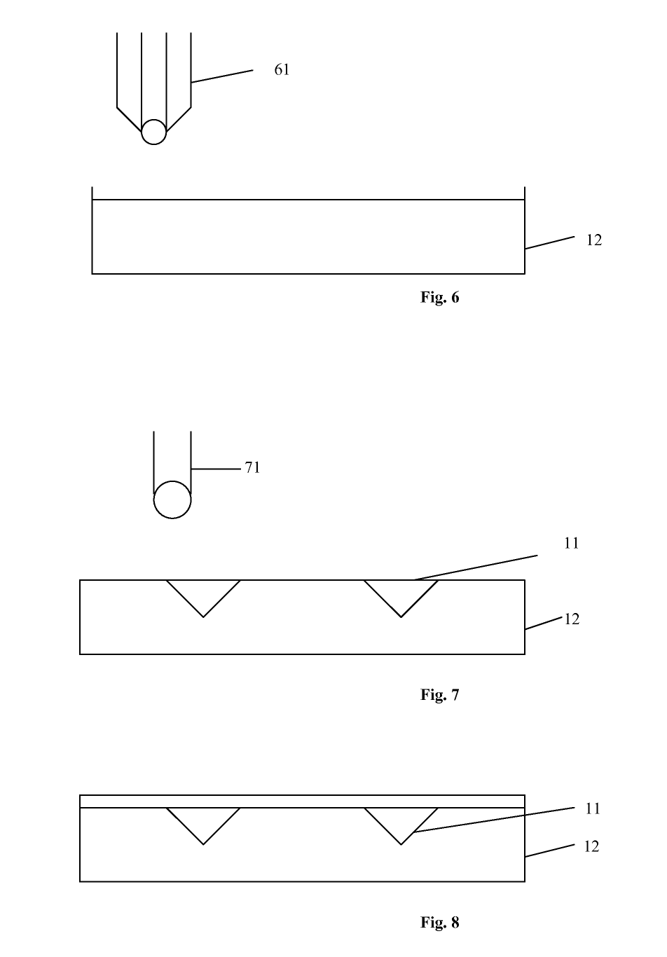

FIG. 6 shows a direct-application fluorescent information mark of the needle impact type, filled using a needle with a hollow channel through which before or during impact a liquid composition which contains a fluorescent dye is sent to the tip of the needle.

FIG. 7 shows a direct-application fluorescent information mark of the needle impact type, filled using a special dispenser which is used for example in injection printing and which applies the necessary amount of the liquid composition which contains the fluorescent paint to each depression.

FIG. 8 shows a direct-application fluorescent information mark of the needle impact type with filled depressions using the method of applying a dye to the surface of the part after formation of the depressions.

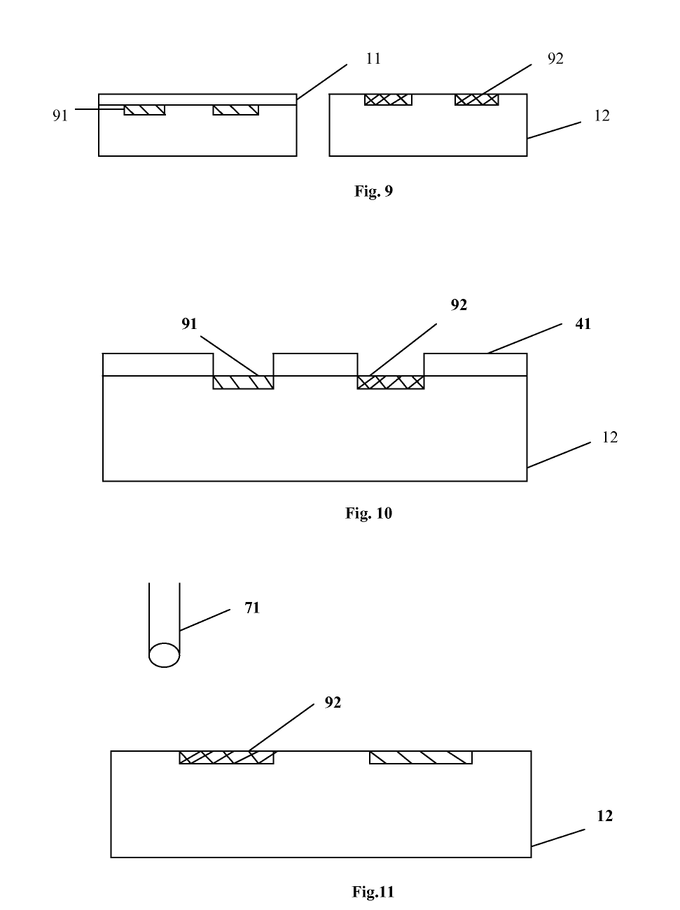

FIG. 9 shows a direct-application fluorescent information mark obtained using the method of laser engraving, with information regions filled with fluorescent paint after engraving, before and after removal of the dye between the information regions.

FIG. 10 shows a direct-application fluorescent information mark obtained using the method of laser engraving, filled with a fluorescent paint using a method which is characterized in that the fluorescent paint using a roller, swab, brush, doctor blade or spraying fills the regions which have been processed using laser radiation in laser engraving through openings in the film which was cemented beforehand to the part and in which process openings were formed in the laser engraving.

FIG. 11 shows a direct-application fluorescent information mark obtained using the method of laser engraving in which the fluorescent paint fills the regions which have been processed by laser radiation in laser engraving using a special dispenser which is used in injection printing and which applies the necessary amount of the liquid composition which contains the fluorescent paint to each region of the information element.

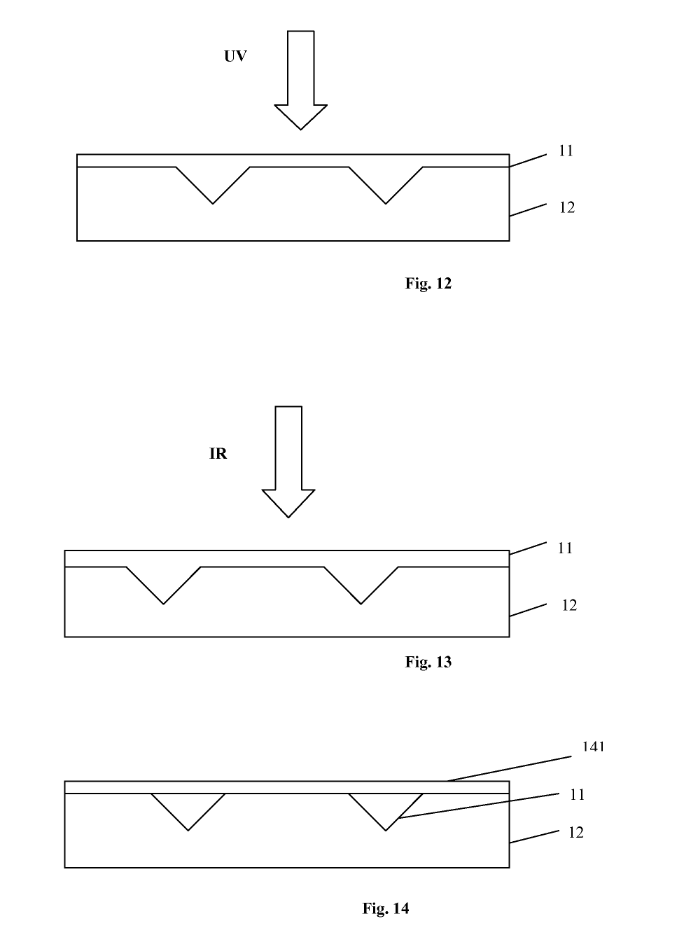

FIG. 12 shows the process of photopolymerization of the mark using UV radiation after filling the depressions of the needle impact mark or regions processed by laser radiation in laser engraving.

FIG. 13 shows the process of drying the mark using IR radiation after filling the depressions or regions processed by laser radiation in laser engraving.

FIG. 14 shows a fluorescent information mark covered by a protective enamel which is transparent in the visible and which absorbs in the UV shortwave ranges.

The following designations are used in FIGS. 1-14: 11—fluorescent paint or polymer composition with fluorescent dye; 12—part to be marked, with information elements, for example depressions of a needle impact mark; 31—needles of a needle impact device; 32—polymer film; 33—polymer composition with fluorescent dye; 34—polymer composition with fluorescent dye which has filled a depression; 41—protective film with openings which have been formed after needle impact marking; 51—film which contains microcapillaries or pores or microcavities with fluorescent paint; 61—needle which has a hollow channel through which before or during impact a liquid composition which contains fluorescent paint travels to the tip of the needle; 71—special dispenser for example which is used in injection printing and which applies the necessary amount of the liquid composition which contains the fluorescent paint to each depression; 91—information region of the SMPN which is obtained by laser engraving and which is not filled with fluorescent paint; 92—information region of the SMPN which is obtained by laser engraving and which is filled with fluorescent paint; 141—protective enamel which is transparent in the visible and absorbent in the US short wavelength ranges.

The direct application symbol mark (SMPN) which is shown in FIGS. 1-2 is for example two-dimensional, in which the information elements, for example depressions of the needle impact mark 12 or regions processed by laser radiation in laser engraving using the methods described below are filled with fluorescent dyes 11.

The distinguishing feature of the proposed SMPN consists in that fluorescent dyes are used which absorb radiation at wavelengths for example either up to the short-wave transmission edge of the filter of the reader in the 250-600 nm range, and which radiate in the wavelength range of the passband of the receiving channel of the reader, for example at 600-700 nm, or which absorb radiation at wavelengths greater than the long wave transmission edge of the filter of the reader, for example in the 700 nm-10 micron range, and which radiate in the wavelength range of the passband of the input filter of the reader, for example 600-700 nm. This makes it possible to read a given mark both by the reflecting readers which are available at a given instant, since the fluorescent dye is transparent at the wavelengths used in them and consequently does not influence the image of the SMPN obtained, and also by special fluorescent readers. They use the radiation of light emitting diodes in the wavelength range of either 250-600 nm, and the image is obtained in the spectral range 600-700 nm, or 700 nm-10 microns, yielding an image also in the 600-700 nm spectral range. It must be noted that the use of fluorescent dyes based on rare earth elements which have narrow fluorescence spectra makes it possible to significantly improve reader operation with strong external illumination under the condition of the corresponding narrowing of the spectral range of its receiving channel.

The methods of producing SMPN which are shown in FIGS. 2-14 with a fluorescent dye are distinguished from the widely used needle impact or laser methods in that additional operations are performed in them and materials are used which make it possible to introduce a fluorescent dye into the information elements of the SMPN.

In FIG. 2 the fluorescent dye 11 in a formulation of a polymer composition or with a solvent is applied directly to the surface of the part 12 with a brush, spray gun or other method before impact which is carried out in the marking process using the needle impact method, for example using an e8-c151za unit from the company SIC. In the impact process some of the dye at the contact site of the needle with the part surface falls into the depressions and the fluorescent paint remaining between the depressions is then removed either by wiping or by rubbing, or by cementing to a removable polymer film with a cementing layer which has good adhesion to the material of the fluorescent dye.

In FIG. 3, in contrast to FIG. 2, the fluorescent dye is applied to the surface of the film 32, for example laysan, clampable or cementable to the surface of the part, in the latter case the dye can be introduced into the cementing layer 33, for purposes of economy the dye can be applied to the film, not continuously, but in the form of regions which correspond to the dimensions of the mark, in the impact process some of the dye 34 located at the contact site of the needle 31 with the surface of the part 12 falls into the depressions, and that remaining between the depressions is then removed along with the polymer film.

In FIG. 4 filling is done after performing the marking operation, the fluorescent dye 34 fills the depressions which have formed after impact through openings in the film 41 which was cemented beforehand to the part 12 and in which openings were formed in the process of needle impact marking.

In FIG. 5, in contrast to FIG. 3, the fluorescent dye is introduced into the interior of the film 33 which contains microcapillaries, or pores, or microcavities 51, in the impact process some of the dye 34 which is located at the contact site of the needle with the part surface falls into the depressions, and does not fall into the space between the depressions 51, since it remains in the film.

FIG. 6 shows application of the fluorescent dye to the needle before marking is carried out. The fluorescent dye is applied to the needle surface before impact over the surface of the part 12 either by immersion of the needle into the liquid composition which contains the fluorescent dye, or in the needle 61 there is a hollow channel through which before or during impact the liquid composition which contains a fluorescent dye travels to the tip of the needle, or the necessary amount of the liquid composition which contains the fluorescent dye is applied to the surface of the needle before impact using a nozzle or contact with a capillary.

In FIG. 7 the fluorescent dye fills the depressions after impact using a special dispenser 71, for example which is used in injection printing and which applies the necessary amount of the liquid composition which contains the fluorescent paint to each depression.

In FIG. 8 the fluorescent dye 11 in a polymer composition formulation or with a solvent is applied directly to the surface of the part 12 with a brush, spray gun or other method after impact. The dye falls into the depressions and also between them. The fluorescent paint remaining between the depressions is then removed either by wiping or by rubbing, or by cementing to a removable polymer film with a cementing layer which has good adhesion to the material of the fluorescent dye.

In FIG. 9 the fluorescent dye 11 in a polymer composition formulation or with a solvent is applied directly to the surface of the part 12 with a brush, spray gun or other method after its processing with laser radiation and formation of the information elements 91 in laser engraving. The dye fills both the information elements and the space between them. The fluorescent paint remaining between the filled information elements 92 is then removed either by wiping or by rubbing, or by cementing to a removable polymer film with a cementing layer which has good adhesion to the material of the fluorescent dye.

In FIG. 10 the fluorescent dye 11 in a polymer composition formulation or with a solvent fills the regions 91 which have been processed with laser radiation, forming fluorescent dye-filled information elements 92 through openings in the film 41 which was cemented beforehand to the part 12 and in which openings were formed in the process of laser engraving.

In FIG. 11 the fluorescent dye 11 in a polymer composition formulation or with a solvent fills the regions 92 which have been processed with laser radiation in laser engraving using a special dispenser 71, for example which is used in injection printing and which applies the necessary amount of the liquid composition which contains the fluorescent paint to each information element.

To improve fixing of the dye and to reduce the dye drying time UV polymerization and IR drying can be used (FIGS. 12 and 13).

FIG. 14 shows that to protect from external action and UV radiation in the process of operation, a protective enamel which is transparent in the visible and absorbent in the UV short wavelength ranges is applied from overhead to the depressions or to the regions processed with laser radiation in laser engraving.

1. Direct application symbol mark (SMPN) which consists of information elements formed on the surface of the part being marked in the form of conical depressions in needle impact marking or sections of the surface with microcracks and roughness which have changed its optical properties, which elements are treated with laser radiation in laser engraving, characterized in that the paint is a fluorescent paint which absorbs radiation at the wavelengths of the near UV, visible and near IR ranges.

2. Fluorescent paints being used as claimed in claim 1, which absorb radiation at the wavelengths of the near UV, visible and near IR ranges, wherein they absorb radiation predominantly either up to the short-wave transmission edge of the filter of the reading device in the 250-600 nm range, and which radiate in the wavelength range of the passband of the receiving channel of the reading device primarily 600-700 nm, or which absorb radiation at wavelengths greater than the long-wave transmission edge of the filter of the reading device, predominantly in the 700 nm-10 micron range, and which radiate in the wavelength range of the passband of the input filter of the reading device, predominantly 600-700 nm.

3. Method of preparation of SMPN which consists of filling the SMPN with paint, wherein it ensures localization of the region of filling only by the information elements which have been formed on the surface of the part being marked in the form of conical depressions in needle impact marking or sections of the surface with microcracks and roughness which have changed its optical properties, which elements are treated with laser radiation in laser engraving,

4. Method of filling marks in needle impact marking as claimed in claim 3, wherein fluorescent paint is applied directly to the surface of the part before impact, in the impact process some of the paint located at the contact site of the needle with the surface of the part falls into the depressions, and the paint which has remained between the depressions is then removed either by wiping or rubbing, or by cementing to a polymer film with a cementing layer which has good adhesion to the material of the fluorescent paint.

5. Method of filling marks in needle impact marking as claimed in claim 3, wherein the fluorescent paint is applied to the surface of the film which can be clamped, in the process of impact some of the paint located at the contact site of the needle with the surface of the part falls into the depressions, and that remaining between the depressions is then removed along with the polymer film.

6. Method of filling marks in needle impact marking as claimed in claim 5, wherein the fluorescent paint is introduced into the cementing layer which is applied to the surface of the film which is being cemented beforehand to the part, in the process of impact some of the paint located at the contact site of the needle with the surface of the part falls into the depressions, and that remaining between the depressions is then removed along with the polymer film with the cementing layer.

7. Method of filling marks in needle impact marking as claimed in claim 5, wherein the fluorescent paint is introduced into the interior of the film which contains microcapillaries or pores or microcavities, in the process of impact some of the paint located at the contact site of the needle with the surface of the part is forced out of the microcapillaries or pores or microcavities and falls into the depressions, and paint does not fall into the space between the depressions, since it remains within the film.

8. Method of filling marks in needle impact marking as claimed in claim 5, wherein to save fluorescent paint, the dye can be applied onto or into the film, not continuously, but in the form of regions which correspond to the dimensions of the mark and marking is done only in these regions.

9. Method of filling marks in needle impact marking as claimed in claim 3, wherein the fluorescent paint, using a roller, swab, brush, doctor blade or spraying fills the depressions which have formed after impact through openings in the film which was cemented beforehand onto the part and in which in the process of needle-impact marking openings were formed.

10. Method of filling marks in needle impact marking as claimed in claim 3, wherein the fluorescent paint is applied to the surface of the needle before impact over the surface of the part by dipping the needle into a liquid composition which contains the fluorescent paint.

11. Method of filling marks in needle impact marking as claimed in claim 10, wherein the fluorescent paint is applied to the surface of the needle before impact over the surface of the part through a hollow channel which is within the needle through which before or during impact the liquid composition which contains a fluorescent dye travels to the tip of the needle.

12. Method of filling marks in needle impact marking as claimed in claim 10, wherein the necessary amount of the liquid composition which contains the fluorescent paint is applied to the surface of the needle before impact over the surface of the part using a nozzle or contact by a capillary with the paint.

13. Method of filling marks in needle impact marking as claimed in claim 3, wherein the fluorescent paint fills the depressions after impact by application of a liquid composition which contains fluorescent paint to the surface of the part, and the dye remaining between the depressions is then removed either by wiping or rubbing or blowing off, or by cementing to a polymer film with a cementing layer which has good adhesion to the material of the fluorescent dye.

14. Method of filling marks in needle impact marking as claimed in claim 13, wherein the fluorescent paint fills the depressions after impact using a special dispenser, for example, which is used in injection printing and which applies the necessary amount of the liquid composition which contains the fluorescent paint to each depression.

15. Regions processed with laser radiation in laser engraving as claimed in claim 3, are filled with fluorescent paint using a method which is characterized in that the fluorescent paint fills the regions processed with laser radiation in laser engraving by application of a liquid composition which contains fluorescent paint to the surface of the part, and the dye remaining between the regions is then removed either by wiping or rubbing or blowing off, or by cementing to a polymer film with a cementing layer which has good adhesion to the material of the fluorescent paint.

16. Regions processed with laser radiation in laser engraving as claimed in claim 3, are filled with fluorescent paint using a method which is characterized in that the fluorescent paint fills the regions processed with laser radiation in laser engraving by preliminary application of a liquid composition which contains fluorescent paint to the surface of the part, with predominantly phthalocyanine or parfirin dyes, which when the regions corresponding to the information elements are irradiated with the laser forms on the surface of the part a film which has good adhesion to the surface of the part, and the dye remaining between the processed regions is then removed either by wiping or rubbing or blowing off, or by cementing to a polymer film with a cementing layer which has good adhesion to the material of the fluorescent paint.

17. Regions processed with laser radiation in laser engraving as claimed in claim 15, are filled with fluorescent paint using a method which is characterized in that the fluorescent paint fills the regions processed with laser radiation in laser engraving using a special dispenser, for example which is used in injection printing and which applies the necessary amount of the liquid composition which contains the fluorescent paint to each region of the information element.

18. Regions processed with laser radiation in laser engraving as claimed in claim 3, are filled with fluorescent paint using a method which is characterized in that using a roller, swab, brush, doctor blade or spraying, the fluorescent paint fills the regions processed using laser radiation in laser engraving through openings in the film which was cemented beforehand onto the part and in which in the process of laser engraving openings were formed.

19. To reduce the drying time as claimed in claim 3, after filling the depressions or regions processed with laser radiation in laser engraving the fluorescent paint can be characterized in that it is produced based on photopolymer compositions and is photopolymerized using UV radiation.

20. To reduce the drying time after filling the depressions or regions processed with laser radiation as claimed in claim 19 in laser engraving the method of processing the fluorescent paint can be characterized in that it is dried using IR drying.

21. To protect from external action and UV radiation in the process of operation, a protective enamel which is transparent in the visible and absorbent in the UV short wavelength ranges can be applied from overhead to the depressions or to the regions processed with laser radiation in laser engraving as claimed in claim 3.
